(19) United States
(12) Patent Application Publication
(10) Pub. No.: US 2025/0348665 A1
(43) Pub. Date: Nov. 13, 2025

(54) METHOD AND APPARATUS FOR SELF-CONSISTENCY BOOSTS CALIBRATION FOR MATH REASONING

(71) Applicant: Tencent America LLC, Palo Alto, CA (US)

(72) Inventor: Linfeng SONG, Bellevue, WA (US)

(73) Assignee: Tencent America LLC, Palo Alto, CA (US)

(21) Appl. No.: 18/662,533

(22) Filed: May 13, 2024

(51) Int. Cl. G06F 40/20

(52) U.S. Cl. CPC G06F 40/20

(57) ABSTRACT

A method includes receiving an input query; generating N sample responses based on the input query using a large language model (LLM), N being an integer greater than zero; organizing the N sample responses into one or more clusters; performing a calibration process on the one or more clusters; and outputting a response to the input query based on the calibration process.

### FIELD

The disclosure generally relates to self-consistency for boosting calibration for math reasoning.

### BACKGROUND

Mathematical reasoning tasks involve mapping a question into a series of equations, which are then solved to obtain the final answer. Math reasoning has long been recognized challenging. Existing solutions propose to map input questions into equations via semantic parsing or AST decoding. Yet, the performance may degrade dramatically even with slight changes to the questions. Recently, large language models (LLM) have shown great potential for solving many math reasoning tasks, even though they are not specifically trained on these tasks. For instance, with chain-of-thought prompting and self-consistency, open-source LLMs, such as Mixtral 8×7B, may reach an accuracy of around 80% on the GSM8K benchmark. However, conventional models that are specifically fine-tuned on the GSM8K training set can only report accuracies around 10% to 20%.

However, LLMs lack adequate calibration out of the box, where the probabilities of model predictions are often poorly aligned with the actual accuracy. Calibration is important for LLM development since a well-calibrated LLM can precisely tell how likely the responses of the LLM are correct or not. With such information, LLM developers may take multiple options to handle low-confidence responses, such as letting the LLM refuse to answer or keep resampling until a confident response is produced.

### SUMMARY

According to one or more embodiments, a method performed by at least one processor, the method comprises: receiving an input query; generating N sample responses based on the input query using a large language model (LLM), N being an integer greater than zero; organizing the N sample responses into one or more clusters; performing a calibration process on the one or more clusters; and outputting a response to the input query based on the calibration process.

According to one or more embodiments, an apparatus comprises: at least one memory configured to store program code; and at least one processor configured to read the program code and operate as instructed by the program code, the program code including: receiving code configured to cause the at least one processor to receive an input query; generating code configured to cause the at least one processor to generate N sample responses based on the input query using a large language model (LLM), N being an integer greater than zero; organizing code configured to cause the at least one processor to organize the N sample responses into one or more clusters; performing code configured to cause the at least one processor to perform a calibration process on the one or more clusters; and outputting code configured to cause the at least one processor to output a response to the input query based on the calibration process.

According to one or more embodiments, a non-transitory computer readable medium having instructions stored therein, which when executed by a processor cause the processor to execute a method comprising: receiving an input query; generating N sample responses based on the input query using a large language model (LLM), N being an integer greater than zero; organizing the N sample responses into one or more clusters; performing a calibration process on the one or more clusters; and outputting a response to the input query based on the calibration process.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is an illustration of a self-consistency calibration framework, according to embodiments.

FIG. 4 is a flowchart of a self-consistency calibration process, according to embodiments.

FIG. 5 is a table of test results, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

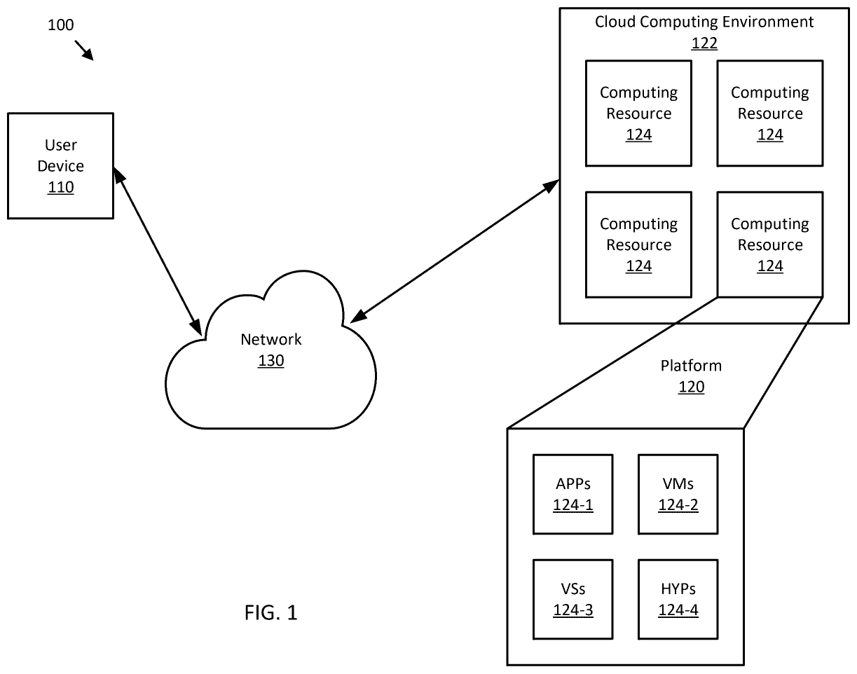

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

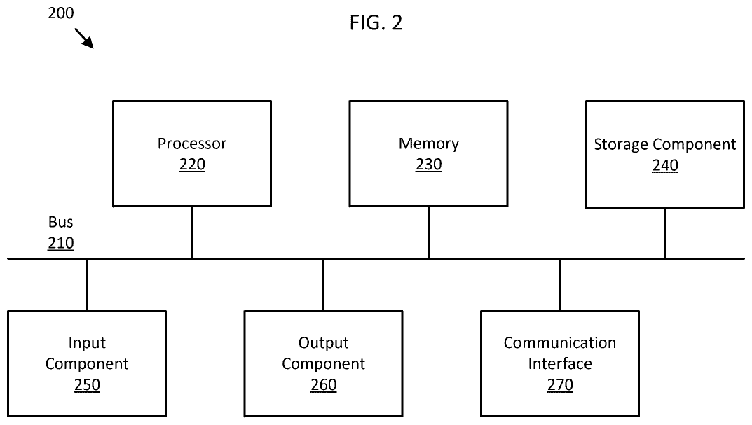

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

Embodiments of the present disclosure are directed to improving large language model (LLM) generations at inference time by mitigating fact-conflicting hallucinations. A hallucination may be an incorrect or non-sensical response from the LLM to an input query. The embodiments of the present disclosure provide a self-endorsement framework that leverages the fine-grained fact-level comparisons across multiple sampled responses. Compared with prior ensemble methods (e.g., self-consistency) that perform response-level selection, the embodiments of the present disclosure better alleviate hallucinations, especially for longform generation tasks. The embodiments of the present disclosure broadly benefit smaller and open-source LLMs as it mainly conducts content-based comparisons. Experiments on Biographies show that the embodiments of the present disclosure effectively improve the factuality of generations with simple and intuitive prompts across different scales of LLMs. Furthermore, comprehensive analyses on TriviaQA and GSM8K demonstrate the potential of self-endorsement for broader application.

According to one or more embodiments, a LLM is a language model notable for its ability to achieve general-purpose language generation and other natural language processing tasks such as classification. They acquire these abilities by learning statistical relationships from text documents during a computationally intensive self-supervised and semi-supervised training process. LLMs can be used for text generation, a form of generative AI, by taking an input text and repeatedly predicting the next token or word.

Accordingly, LLMs rely on machine learning algorithms for training and generating an output based on an input query. Because machine learning algorithms may process numbers rather than text, the text may be converted to numbers. In a first step, a vocabulary is decided upon, then integer indexes are arbitrarily but uniquely assigned to each vocabulary entry, and finally, an embedding is associated to the integer index. Algorithms may include byte-pair encoding and WordPiece. Probabilistic tokenization also compress the datasets. Because LLMs generally require input to be an array that is not jagged, the shorter texts must be “padded” until they match the length of the longest one. How many tokens are, on average, needed per word depends on the language of the dataset.

In one or more examples, using a modification of byte-pair encoding, in a first step, all unique characters (including blanks and punctuation marks) are treated as an initial set of n-grams (e.g., initial set of uni-grams). Successively the most frequent pair of adjacent characters is merged into a bi-gram and all instances of the pair are replaced by it. All occurrences of adjacent pairs of (previously merged) n-grams that most frequently occur together are then again merged into even lengthier n-gram repeatedly until a vocabulary of prescribed size is obtained (in case of GPT-3, the size is 50257). Token vocabulary consists of integers, spanning from zero up to the size of the token vocabulary. New words can always be interpreted as combinations of the tokens and the initial-set uni-grams.

A token vocabulary based on the frequencies extracted from mainly English corpora uses as few tokens as possible for an average English word. An average word in another language encoded by such an English-optimized tokenizer is however split into suboptimal amount of tokens. GPT-2 tokenizer can use up to 15 times more tokens per word for some languages, for example for Shan language from Myanmar. Even more widespread languages such as Portuguese and German have “a premium of 50%” compared to English

The embodiments of the present disclosure are directed to performing calibration on an LLM, which establishes a correlation between accuracy and model confidence, and is significantly important for LLM development. The embodiments of the present disclosure include three off-the-shelf calibration methods based on self-consistency for tasks performed by the LLM such as math reasoning tasks. Evaluation on two popular benchmarks (GSM8K and MathQA) using strong open-source LLMs (Mistral and LLAMA2), demonstrate that the embodiments of the present disclosure better bridge model confidence and accuracy than existing methods based on p(True) or logit.

The embodiments of the present disclosure utilize calibration methods based on self-consistency LLM tasks such as reasoning tasks. In one or more examples, a math reasoning task may be a math word problem that is inputted into the LLM, where the LLM is expected to resolve the math word problem. A self-consistency method may perform clustering over multiple LLM samples before picking one from the largest cluster as the response to each input query. The embodiments of the present disclosure implement several ways to estimate model confidence using the clustering results including, but not limited to: cluster size that estimates how many samples agree with the selected one, cluster number that measures to what extent samples disagree with each other, and pairwise comparison that captures relative differences between pairs of clusters. Based on these embodiments, LLM developers may advantageously take multiple options to handle low-confidence responses, such as letting the LLM refuse to answer or keep resampling until a confident response is produced.

For math reasoning, there are usually multiple trajectories to reach the final solution. To replicate this process, self-consistency initially samples various reasoning paths r₁, . . . , r_{N} from the LLM given input x with Chain-of-Thought (CoT) prompting. In one or more examples, an LLM may produce N samples by inputting an input x into the LLM N different times. Subsequently, the answers a₁, . . . , a_{N} are extracted from the paths, and the most consistent answer (the one win by majority vote among the answers) is selected as the final answer a:

$$a = {max}_{\hat{a}} {\sum }_{i = 1}^{N} 𝕀 ( {a}_{i} = \hat{a} ) , \qquad Eq . ( 1 )$$

where rᵢ, aᵢ denote the i-th sampled reasoning path and its corresponding answer, respectively.

According to one or more embodiments, after performing self-consistency on input x using LLM, we obtain a set of clusters C={c₁, . . . , c_{|c|}} with each cluster cᵢ comprising nᵢ sampled responses with the same answers. The embodiments of the present disclosure implement the following strategies, tailored to the characteristics of these clusters, to estimate the confidence of LLM.

In one or more examples, the Cluster Number |C| may be considered. This strategy is motivated by the finding of self-consistency: LLMs tend to generate consistent answers when they are confident about their predictions, and thus, the cluster number (number of distinct answers) tends to be small. In one or more examples, each of N samples may be organized into one or more clusters where two samples having similar or identical answers are organized into a same clusters. Therefore, a fewer number of clusters may indicate higher confidence in the output of the LLM.

In one or more examples, the he cluster number is divided by the sample size N to normalize the score into the range of [0, 1], before reversing it by “1-x”:

$${F}_{CN} = 1 - \frac{\vert C \vert}{N} \qquad Eq . ( 2 )$$

In one or more examples, the cluster size may be adopted. The cluster size may be the number of samples (e.g., nᵢ) within a specific cluster (e.g., cᵢ). In one or more examples, the cluster size proportion relative to the total sample size to normalize the score into the range [0, 1] is computed as follows:

$${F}_{CS} = \frac{{n}_{i}}{N} \qquad Eq . ( 3 )$$

In contrast to the cluster number, the cluster size is more universally applicable across diverse prompts, as the cluster number may become less indicative of accuracy when the output space of an LLM is restricted, such as when options for a question are provided.

The cluster number and cluster size primarily consider the number of distinct answers and the number of sampled paths within a single cluster, respectively. Theses parameters both overlook the information by comparing different clusters. For example, these parameters may fail to consider the situation when the sizes of the top-ranked clusters are close. As a result, in one or more examples, a Pairwise Comparison method is implemented, which computes the winning rate of the chosen cluster (cᵢ) against each of the remaining clusters as follows:

$${F}_{PC} = {\prod }_{j \neq i}^{\vert C \vert} \frac{{n}_{i}}{{n}_{i} + {n}_{j}} \qquad Eq . ( 4 )$$

where

$$\frac{{n}_{i}}{{n}_{i} + {n}_{j}}$$

represents the winning rate of selected cluster cᵢ against another cluster cⱼ.

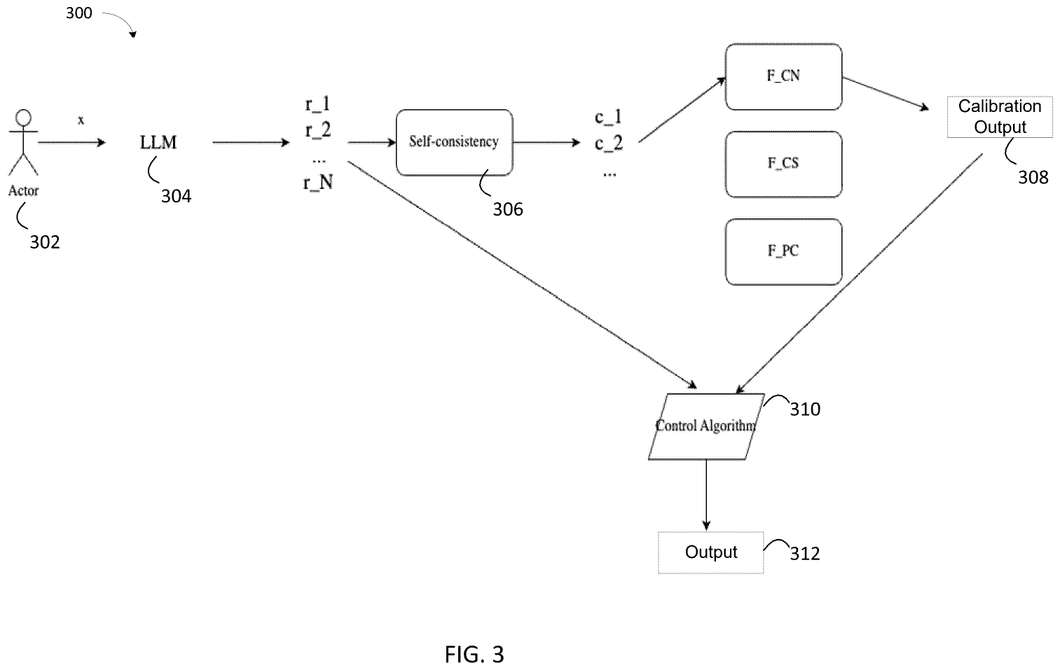

FIG. 3 illustrates an example framework 300 for calibrating an LLM. An actor 302 (e.g., user) may provide an input x to an LLM 304. The input x may be a math word problem. The LLM 304 may produce N samples (e.g., r_1 to r_N) by inputting the LLM 304 into the LLM N different times.

In one or more examples, self-consistency 306 be performed on the N samples. The self-consistency 306 may include organizing the N sample responses into one or more clusters. For example, each sample response having identical or similar answers are organized into the same cluster.

Calibration may be performed on the clusters to obtain calibrations scores F_CN, F_CS, and/or F_PC as discussed above. In one or more examples, the calibration output 308 may be a selection of a highest calibration score. In one or more examples, the calibration output 308 may be an average or weighted average of the calibration scores.

The calibration output 308 may be provided to a control algorithm 310. In one or more examples, the control algorithm 310 may process the calibration output 308 to determine an output 312. For example, if the calibration output is a value that is below a threshold, it may be determined that there is a low level of confidence in the N samples produced from the LLM. Therefore, the output 312 provided to the actor 302 may be “Invalid Output,” “I'm not sure,” “Please rephrase question,” etc. In one or more examples, the control algorithm 310 may select one of the N sample responses as the output. For example, the control algorithm may select a response corresponding to a cluster having the highest F_CN, F_CS, or F_PC score.

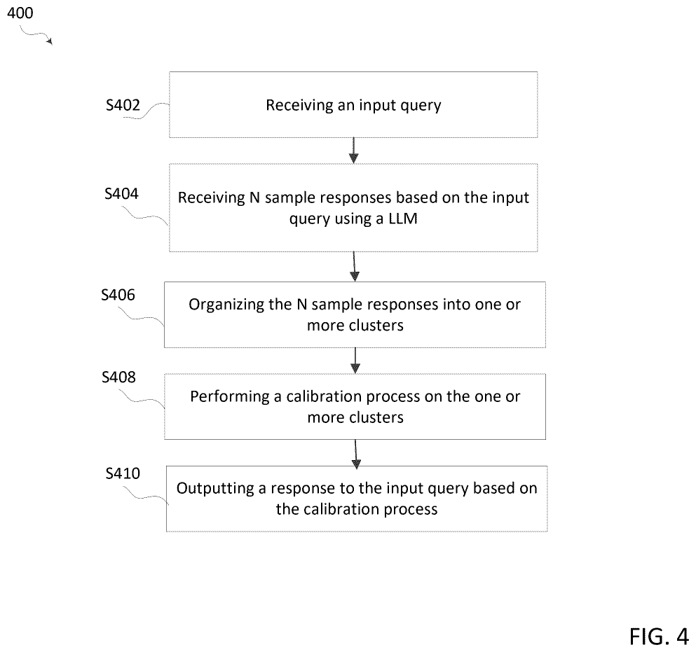

FIG. 4 illustrates a flowchart of an example process 400 of performing a self-consistency calibration process. The process 400 may be performed by the device 200.

The process may start at operation S402 where an input query is received. For example, the input query may be a math word problem. An example math word problem may be, but not limited to, one of the following: (i) “Old Town Bike Rental Shop charges 20 dollars plus 7 dollars an hour for renting a bike. Ted paid 80 dollars to rent a bike. How many hours did he pay to have the bike checked out?”; (ii) “Jane collects stamps. In her album she can fit 20 stamps on a page. She has filled 12 pages. How many stamps has Mary collected?”; (iii) “Mike put 3 souffles in his oven at 5:00 pm. He cooked them for 15 minutes. He repeated this process two more times. At what time did he finish cooking all the soufflés.”

The process proceeds to operation S404 where N sample responses are received based on the input query using a LLM. For example, the input query may be provided to the LLM N different times to obtain the N samples.

The process proceeds to operation S406 where the N samples are organized into one or more clusters. For example, each sample response having a similar or identical answer are organized into the same response.

The process proceeds to operation S408 where a calibration process may be performed on one or more clusters. For example, the calibration process may be performed as discussed above to obtain F_CN, F_CS, or F_PC.

The process proceeds to operation S410 where a response is outputted based on the calibration process. For example, one of the N sample responses exhibiting a high degree of confidence may be selected as the output. In another example, when none the samples exhibit a high degree of confidence, the output may be “Please rephrase question,” etc.

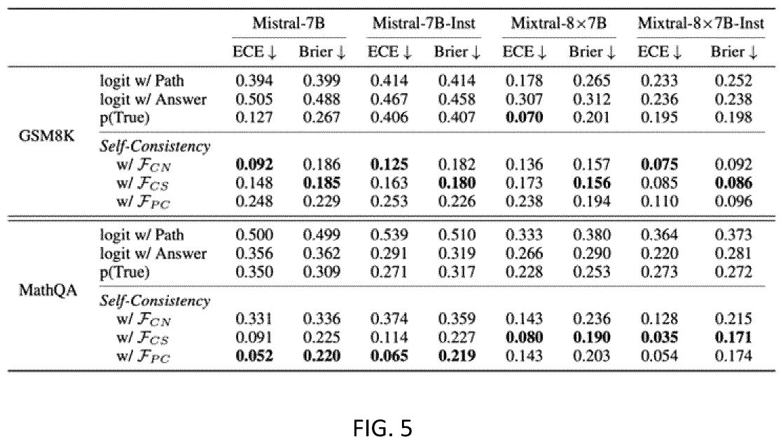

FIG. 5 illustrates a table demonstrating results using the embodiments of the present disclosure. Experiments were conducted on two popular math reasoning benchmarks of different type of questions, GSM8K and MathQA. Particularly, GSM8K comprises 1,319 linguistically diverse grade school math word problems for testing. On the other hand, MathQA offers 2,985 multiple-choice math word problems for evaluation. A Brier Score and Expected Calibration Error (ECE) were adopted as evaluating metrics following common practice. The experiments were conducted on Mistral-family models to investigate both pre-trained or instruction-tuned variations.

FIG. 5 presents the main results obtained from both benchmarks using Mistralfamily models. As illustrated in FIG. 5, p(True) performs best among the baselines. However, due to its reliance on prompt design and in-context examples to aid the LLM to classify its predictions, it can be challenging to construct effective demonstrations or instructions. In general, self-consistency-based methods surpass baselines in most cases regarding Brier and ECE, validating the efficacy of employing self-consistency features for estimating model confidence. It is noted that baselines can occasionally yield impressive ECE scores (p(True) on GSM8K with Mixtral-8×7B). However, it was observed that this is attributed to the concentration of most samples in just a few bins, leading to unreliable measurements. However, the embodiments of the present disclosure still exhibit strong performance in terms of ECE scores across various settings.

The proposed methods disclosed herein may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor, the method comprising:
receiving an input query;
generating N sample responses based on the input query using a large language model (LLM), N being an integer greater than zero;
organizing the N sample responses into one or more clusters;
performing a calibration process on the one or more clusters; and
outputting a response to the input query based on the calibration process.

2. The method according to claim 1, wherein the organizing the N sample responses into the one or more clusters comprises organizing each sample response having a same answer into a same cluster.

3. The method according to claim 1, wherein the calibration process determines a calibration score,
wherein based on a determination the calibration score is greater than or equal to a threshold, the outputted response is one of the N sample responses, and
wherein based on a determination the calibration score is less than the threshold, the outputted response is an output indicating that the input query is invalid.

4. The method according to claim 1, wherein the calibration process comprises determining a calibration score based on a number of clusters.

5. The method according to claim 4, wherein the calibration score is normalized based on dividing the number of clusters by N.

6. The method according to claim 1, wherein the calibration process comprises determining a calibration score based on a cluster size of each of the one or more clusters.

7. The method according to claim 6, wherein the cluster size of each of the one or more clusters is normalized by dividing each of the one or more clusters by N.

8. The method according to claim 1, wherein the calibration process comprises, for each cluster:
determining a cluster size of each cluster from the one or more clusters, and
determining, for each cluster, a calibration score based on a product of (i) the cluster size of a respective cluster divided by a sum of the cluster size of the respective cluster and the cluster size of a first cluster other than the respective cluster with (ii) the cluster size of the respective cluster divided by a sum of the cluster size of the respective cluster and the cluster size of a second cluster other than the respective cluster.

9. The method of claim 1, wherein the input query is a word math problem.

10. The method of claim 1, wherein the N sample responses are generated by inputting the input query into the LLM N different times.

11. An apparatus comprising:
at least one memory configured to store program code; and
at least one processor configured to read the program code and operate as instructed by the program code, the program code including:
receiving code configured to cause the at least one processor to receive an input query;
generating code configured to cause the at least one processor to generate N sample responses based on the input query using a large language model (LLM), N being an integer greater than zero;
organizing code configured to cause the at least one processor to organize the N sample responses into one or more clusters;
performing code configured to cause the at least one processor to perform a calibration process on the one or more clusters; and
outputting code configured to cause the at least one processor to output a response to the input query based on the calibration process.

12. The apparatus according to claim 11, wherein the organizing code further causes the at least one processor to organize each sample response having a same answer into a same cluster.

13. The apparatus according to claim 11, wherein the calibration process determines a calibration score,
wherein based on a determination the calibration score is greater than or equal to a threshold, the outputted response is one of the N sample responses, and
wherein based on a determination the calibration score is less than the threshold, the outputted response is an output indicating that the input query is invalid.

14. The apparatus according to claim 11, wherein the calibration process comprises determining a calibration score based on a number of clusters.

15. The apparatus according to claim 14, wherein the calibration score is normalized based on dividing the number of clusters by N.

16. The apparatus according to claim 11, wherein the calibration process comprises determining a calibration score based on a cluster size of each of the one or more clusters.

17. The apparatus according to claim 16, wherein the cluster size of each of the one or more clusters is normalized by dividing each of the one or more clusters by N.

18. The apparatus according to claim 11, wherein the calibration process comprises, for each cluster:
determining a cluster size of each cluster from the one or more clusters, and
determining, for each cluster, a calibration score based on a product of (i) the cluster size of a respective cluster divided by a sum of the cluster size of the respective cluster and the cluster size of a first cluster other than the respective cluster with (ii) the cluster size of the respective cluster divided by a sum of the cluster size of the respective cluster and the cluster size of a second cluster other than the respective cluster.

19. The apparatus of claim 1, wherein the input query is a word math problem.

20. A non-transitory computer readable medium having instructions stored therein, which when executed by a processor cause the processor to execute a method comprising:
receiving an input query;
generating N sample responses based on the input query using a large language model (LLM), N being an integer greater than zero;
organizing the N sample responses into one or more clusters;
performing a calibration process on the one or more clusters; and
outputting a response to the input query based on the calibration process.
